(19) United States
(12) Patent Application Publication
(10) Pub. No.: US 2007/0207644 A1
(43) Pub. Date: Sep. 6, 2007

(54) Fixing member for electric conductors, electric conductor structure component and method for producing such a component

(75) Inventors: Robert Pollmann, Karlstein (AT); Harald Weber, Karlstein (AT); Walter Wimmer, Weikertschlag/Thaya (AT)

Correspondence Address: William R. Evans;Ladas & Parry LLP, 26 West 61 Street, New York, NY, 10023, US

(73) Assignee: POLLMANN AUSTRIA OHG.

(21) Appl. No.: 11/706,851

(22) Filed: Feb. 15, 2007

(30) Foreign Application Priority Data
Mar. 3, 2006 (AT) A 365/2006
May 30, 2006 (AT) A 931/2006

(51) Int. Cl. H01R 13/44

(52) U.S. Cl. 439/131

(57) ABSTRACT

For a conductor structure component with plastics material injection-molded therearound, a fixing member for electric conductors is inserted, which fixing member is formed by a prefabricated carrier body comprising receptacles for the retention of individual wires as said electric conductors.

### FIELD OF INVENTION

The invention relates to a fixing member for electric conductors, for producing a conductor structure component by injecting plastics material therearound.

Moreover, the invention relates to an electric conductor structure component comprising such a fixing member and electric conductors within a plastics material injected therearound.

Furthermore, the invention relates to a method for producing an electric conductor structure component, wherein plastics material is injected around electric conductors.

### BACKGROUND OF INVENTION

From DE 10 2004 020 085 A1 and EP 1 357 774 A1 it is known to use metallic punched grates as basic element for the production of components comprising electric conductor structures. In an injection mold, plastics material is partially injected around these punched grates in advance so that individual regions of the punched grate are interconnected and, thus, fixed by the plastic elements. Subsequently, webs which originally had been required for the coherence of the punched grate and which have become unnecessary because of the plastics material injected around the conductors, i.e. because of the plastic fixing elements, are severed. Optionally, electronic components may be applied to the punched grate, e.g. by soldering them thereto. Subsequently, in a further injection procedure, plastics material is injected around the punched grate as a whole for insulation purposes and for obtaining a stable, readily mountable component, the component obtained thereby being well insulated against external influences, such as moisture. As a consequence, these components are suitable i.a. for applications in motor vehicles, e.g. in the region of doors, for door locks, power windows, yet also for windshield wiper systems and the like installations having electric components.

From DE 1 190 544 A (=BE 658 431 A) and DE 1 590 728 A, on the other hand, it is known to produce several serially arranged contacts, in particular sliding switches, by fixing short, adjacently arranged wires in an isulating strip. The ends of the wires project from both sides of the insulating strip and are shaped into contact elements by embossing. In the insulating strips, the wires may be pressed in, clamped in or glued in, yet the insulating strip may also be injection molded around them or pressed around them.

From U.S. Pat. No. 4,965,933 A, the production of conductive tracks with plastics material injected therearound is known, wherein conductive tracks which previously have been interconnected by connecting elements must be separated from each other within the mold before the plastics material is injected thereinto. This is an additional step which increases expenditures, with the additional risk that when the plastics material is injected into the mold, the separated conductive track elements might unintentionally shift.

DE 102 22 285 C1 describes the production of a flat band conductor by extrusion, with the conductive tracks being fixed in an insulation element in a first step, whereupon the insulation is completed in a second step.

From DE 102 47 567 A1 a housing-type carrier for electric components is known at the production of which conductive tracks punched from sheet are enclosed by plastics material injected therearound, with contacting sites of the conductive tracks projecting from the carrier.

### SUMMARY OF INVENTION

It is now an object of the invention to enable a particularly simple and cost-effective production of conductor structure components and also to provide an advantageous fixing member therefor, wherein, moreover, a high degree of flexibility, e.g. for short-term changes of the conductor positions, shall be ensured.

To achieve this object, the invention provides a fixing member for electric conductors for the production of a conductor structure component by injecting plastics material therearound, said fixing member comprising a prefabricated carrier body with receptacles for the retention of individual wires as electric conductors.

The invention further provides for an electric conductor structure component comprising a fixing member according to the invention and electric conductors within a plastics material injected therearound, wherein wires are retained in receptacles of the carrier body of the fixing member, and wherein the carrier plate including the wires are embedded by plastics material being injection-molded therearound.

Moreover, the invention also provides for a method of producing an electric conductor structure component, said method comprising the steps of producing a carrier body having receptacles for wires, providing and inserting wires as electric conductors in the receptacles of the carrier body and fixing them in their position therein, and injection-molding plastics material around the carrier body including the wires.

With the technique according to the invention, a separate, prefabricated element in the form of a—preferably plate-shaped—carrier body is used as fixing member, and instead of being provided by a punched grate, the conductors are provided by wires held on this carrier body. For this purpose, the carrier body has appropriate mountings, receptacles or seats (in the following in short receptacles) for the wires, wherein the wires may be retained in the associated receptacles by a slight press fit, by a snap fit, or by a latch fit, respectively, and/or by positive engagement. The fixing of the wires on the carrier body must only be sufficient for preventing detachment of the wires from their receptacles when plastics material is injected around the carrier body including the wires. Here it is particularly advantageous if the receptacles at least in regions thereof are channel-shaped, these channel-shaped receptacles being formed e.g. by depressions in the carrier body and/or being delimited by channel walls projecting upwards from the carrier body. The receptacles may be undercut, viewed in cross-section, e.g. so as to form elastically deformable latching fits, yet they may also be embossed by means of a stamp die, optionally under application of heat, after the insertion or pulling in of the wires, so that the wires will be positively held in the respective receptacles. Additionally or thereinstead, for elastically fixing the wires on the carrier body it is also possible to provide at least one elastically deformable retention clip or clamping element as a snap retention means for the respective accommodated wire. This clamping element, or retention clip, respectively, will be particularly provided in the region of an arcuate path of the wire on the carrier body, since there, possibly higher forces might act on the respective wire.

Preferably, the carrier body is an injection molded plastics material element which will be defined in terms of dimensions and shape depending on its specific application; in this respect, particularly the channel-shaped receptacles just as the retention clips possibly present can be co-injected without any problems, wherein at least in certain regions, the aforementioned undercut portions on the channel-shaped receptacles can be produced at the same time, if a snap retention or latching engagement in the elastically deformable receptacles is to be provided.

Furthermore, plug contacts can be fixedly provided on the carrier body, on at least one rim thereof, e.g. by tight clamping, and the wires retained in the receptacles are electrically connected to these plug contacts, e.g. by soldering, welding, by clamping or by cutting contacts or the like connecting techniques. In the finished conductor structure component, these plug contacts will project from the plastics material injection-molded therearound, and if desired, they may also be surrounded by a plastics material housing element which is integrally formed with the injected-around material for protection and sealing purposes.

If an electric component, such as a switch and/or an electric motor, is to be externally fastened to the conductor structure component later on, it is suitable to bend the corresponding wires away from the carrier body for connecting these components to the conductor structure, wherein, in the finished conductor component, the bent away wire portions will project outward from the plastics material injected therearound to thereby enable the electric connection to the respective component.

In method terms, a simplification will result for the production of an inventive electric conductor structure component insofar as merely an adapted carrier body must be provided in advance for receiving the wires, which can be effected without any problems by injection-molding with plastics material in the most varying shapes, whereupon wires will simply be inserted as electric conductors in the receptacles of the carrier body and fixed therein, with plastics material finally being injected around the carrier body including the wires. Insertion of the wires preferably is effected by means of a per se conventional wire insertion robot, wherein complex electric connections are possible, and wherein also carrier bodies fitting the respective instance and, thus, changes of the conductive tracks are possible in a simple manner. With the present technique, the comparatively complex production of metallic punched grates as required in the prior art is omitted, resulting in an extremely cost-effective production.

### BRIEF DESCRIPTION OF THE DRAWINGS

The invention will be explained in more detail hereinafter by way of particularly preferred exemplary embodiments to which, however, it shall not be restricted, and with reference to the accompanying drawings. In the drawings, FIG. 1 schematically shows a perspective illustration of a conductor structure component comprising a carrier body, wires affixed thereto, a plastics material injected therearound being indicated in broken lines;

FIG. 2 shows a part of the carrier body provided in the component of FIG. 1, including wires;

FIG. 3 shows a section from the carrier body according to FIG. 2, according to detail III; in a perspective view, so as to illustrate retention clips;

FIG. 4 shows a partial cross-section according to line IV-IV of FIG. 3 to illustrate the shape and effect of the retention clips;

FIG. 5 is a perspective illustration of a modified conductor structure component according to the invention with an electric motor fastened thereto, with a switch also fastened thereto as well as with an arrangement of plug contacts having a housing-shaped encasement;

FIG. 6 shows a top view on the arrangement according to FIG. 5;

FIG. 7 shows a section through this arrangement according to line VII-VII of FIG. 6;

FIGS. 8a and 8b show the details VIIIa and VIIIb from FIG. 6 in an enlarged scale;

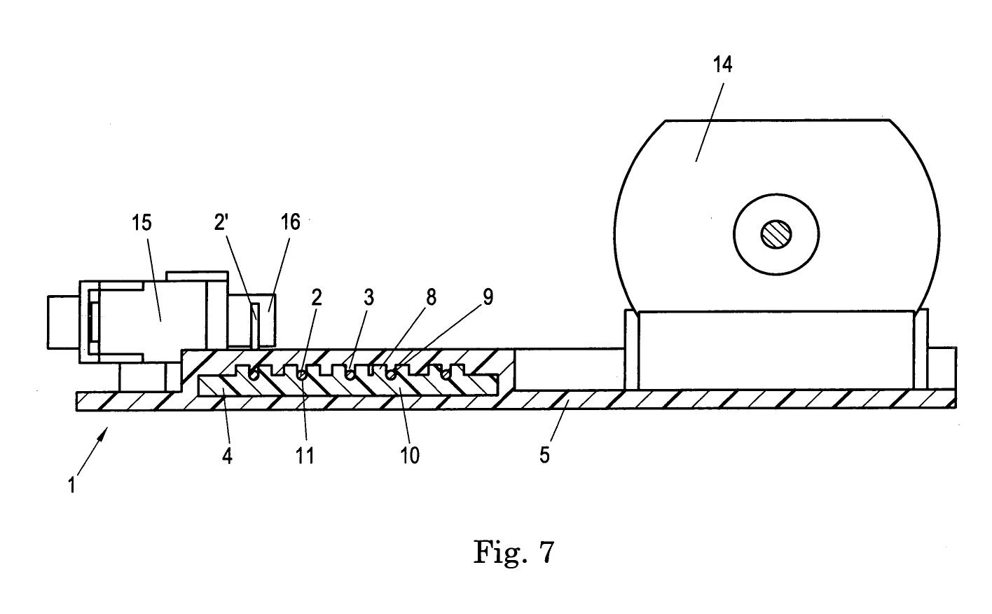

FIG. 9 shows in perspective view the carrier body for the component according to FIG. 5 including the wires held thereon as electric conductors as well as plug contacts, before the plastics material is finally injected therearound;

FIG. 10 shows the lower side of the carrier body according to FIG. 9 in a perspective view;

FIG. 11 shows a part of the carrier body according to FIG. 10 in a corresponding bottom view, yet on an enlarged scale, with the plug contacts, according to detail XI of FIG. 10;

FIG. 12 is a perspective illustration of a fixing member provided for producing a conductor structure component according to FIG. 17, which fixing member is stationarily arranged on a rigid substructure which forms a counter-tool during an embossing step;

FIG. 13 shows the fixing member on the substructure in a schematic section, as well as an embossing stamp arranged thereabove and approached to the upper side of the fixing member;

FIG. 14 shows the region of a receptacle of the carrier body of the fixing member in a detailed section according to the detail XIV of FIG. 13, it being visible that this receptacle is closed on its upper side by the embossing stamp, and wherein—in comparison with FIG. 13—a wire has already been inserted in the receptacle;

FIG. 15 shows the arrangement of embossing stamp, carrier body and substructure according to FIG. 14 following the embossing step, wherein the wires fixed on the carrier body are held by positive engagement due to embossing;

FIG. 16 shows the carrier body with the positively engaged anchorage of a wire produced by embossing or stamping in a detailed section on an enlarged scale according to the detail XVI of FIG. 15; and

FIG. 17 shows a perspective illustration comparable to FIG. 12 of the completed conductor structure component, yet before the plastics material is injected therearound.

### DETAILED DESCRIPTION OF THE DRAWINGS

In FIG. 1, in a perspective illustration there is shown a simple component 1 comprising an electric conductor structure which contains several wires 2 as electric conductors which, as required and necessary, follow a straight, angular, curved etc. course within the component 1, depending on the purpose for which said component 1 is used.

In detail, the wires 2 are fixed in receptacles 3 of a preferably plate-shaped carrier body 4, which is provided as conductor fixing member 4′. This exemplary plate-shaped carrier body 4 will also simply be termed carrier plate 4 hereinafter. As such, however, the carrier body 4 may, for instance, also be cuboid for certain applications, yet the plate shape as a rule is preferred because of the possibility of accommodating many wires 2, also with a curved course, in space-saving manner. The carrier plate 4 together with the wires 2 is embedded in a plastics material 5 injected therearound, this plastics material being merely hinted in broken lines in FIG. 1 for the sake of a clearer illustration of the remaining elements.

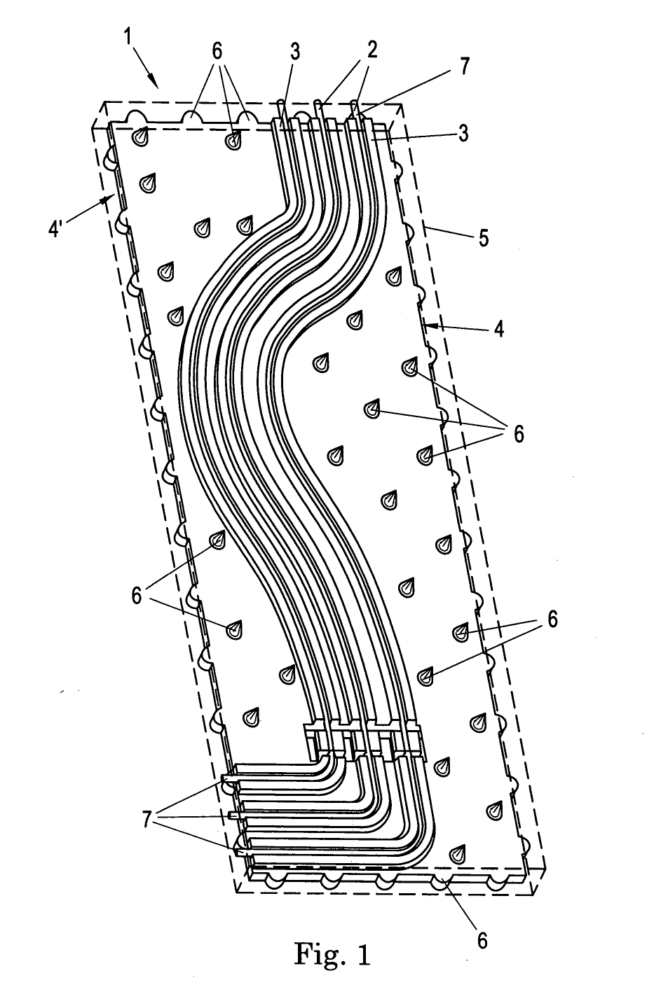

For producing this injection-molded plastics body 5, the carrier plate 4 including the wires 2 retained in the receptacles 3 is laid into a known per se injection-molding tool (not illustrated) and then plastics material is injected therearound, as is known per se, wherein, e.g., nodule-shaped spacer elements 6 keep the carrier plate 4 in position within the injection-molding tool by abutting on corresponding areas of the tool. From the thus formed component, ends 7 of the wires 2 project from the component 1 for contacting purposes, cf. also FIG. 2 in addition to FIG. 1, in which a region of the carrier plate 4 including the wires 2 fixed in the receptacles 3 is illustrated on an enlarged scale, with the plastics material not yet having been injected therearound.

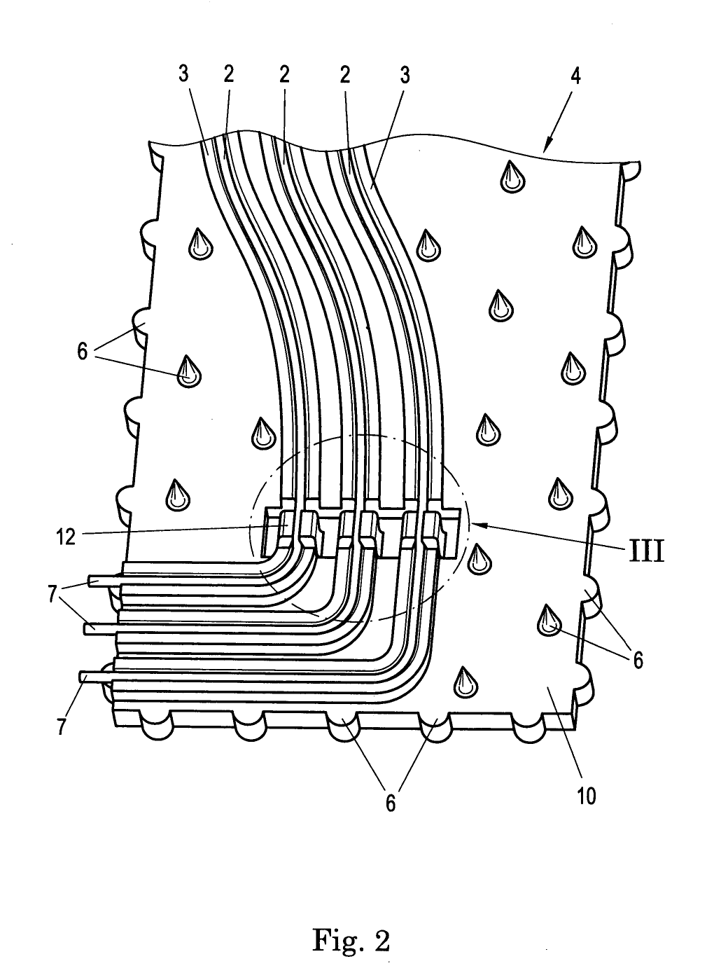

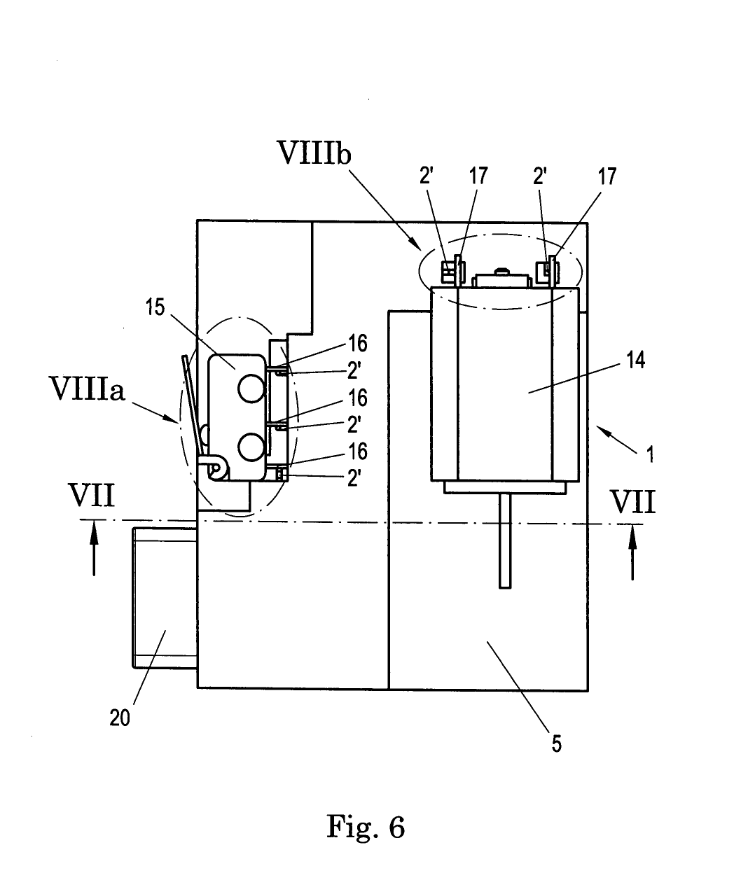

As can particularly be seen from FIG. 3 in addition to FIGS. 1 and 2, the receptacles 3 are channel-shaped, the channel-shaped receptacles 3 being delimited by walls 8, 9, cf. also the cross-sectional illustration of FIG. 7. On the one hand, the channel-shaped receptacles 3 are delimited by these walls 8, 9 which extend upwards from the main body 10 of the carrier plate 4, partially, however, they are also formed by depressions or grooves 11 formed in the main body 10 of the carrier plate (cf. FIG. 7), i.e. the bottom of the grooves constituting the receptacles 3 is located somewhat lower in comparison with the upper main surface of the main body 10 of the carrier plate 4, and, on the other hand, the walls 8, 9 extend upwards from the main body 10 of the carrier plate 4; in this way, a limited lateral elastic deformation of the walls 8, 9 is possible so that the walls 8, 9 may be formed with slightly undercut portions at their upper side, or may be provided with a narrow mutual spacing so that the wires 2 can be retained in the channel-shaped receptacles 3 in a snap fit, or in a slight press fit, respectively.

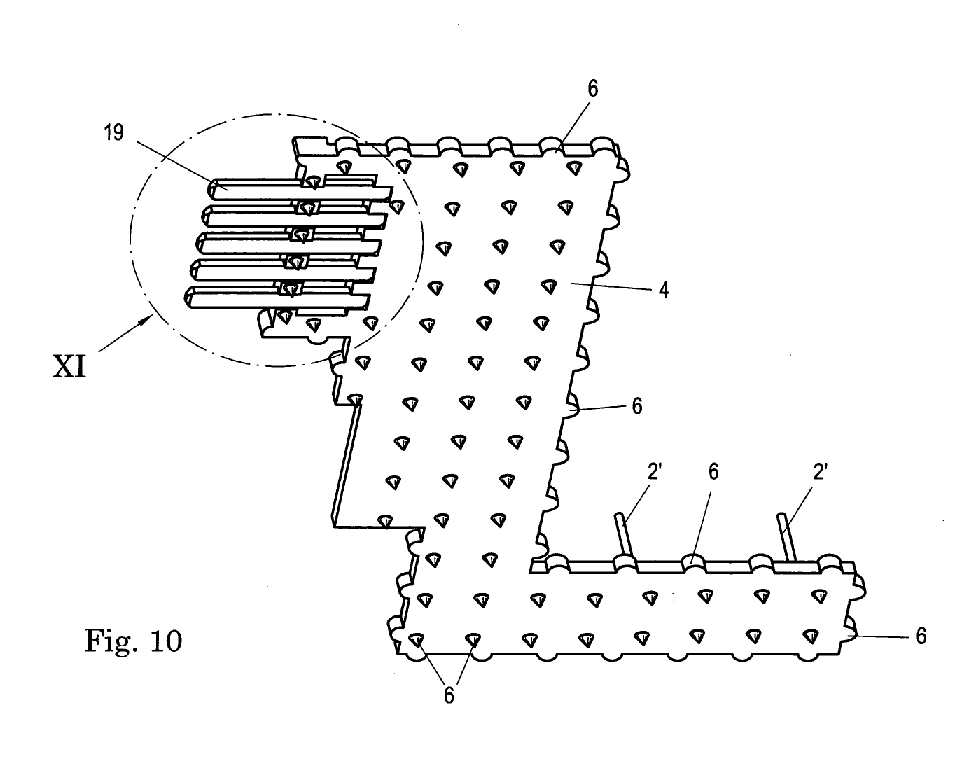

Another possible way of fixing the wires 2 in the receptacles 3 consists in stamping or embossing the upper side of the carrier plate 4, i.e. of the walls 8, 9, with a suitable, optionally heated, stamp die, or embossing stamp, respectively, so that the walls 8, 9 will be plastically deformed and, thus, the wires 2 will be retained with positive engagement in the grooves of the receptacles 3 by overlapping portions of the walls obtained by said deformation. Here, the wires 2 may either be laid from the top into the upwardly still open receptacles 3, whereupon embossing is effected; or after the receptacles 3 have been closed on their upper side by means of an embossing stamp, the wires 2 may be pushed into the then tunnel-like receptacles. Subsequently, in both cases the (final) embossing of the carrier plate 4 is effected by a relative movement of embossing stamp and substrate (with carrier plate 4) towards each other for deforming the rims of the receptacles 3 for the wires 2. An appropriate technique will be explained in more detail hereinafter by way of FIGS. 12 to 17.

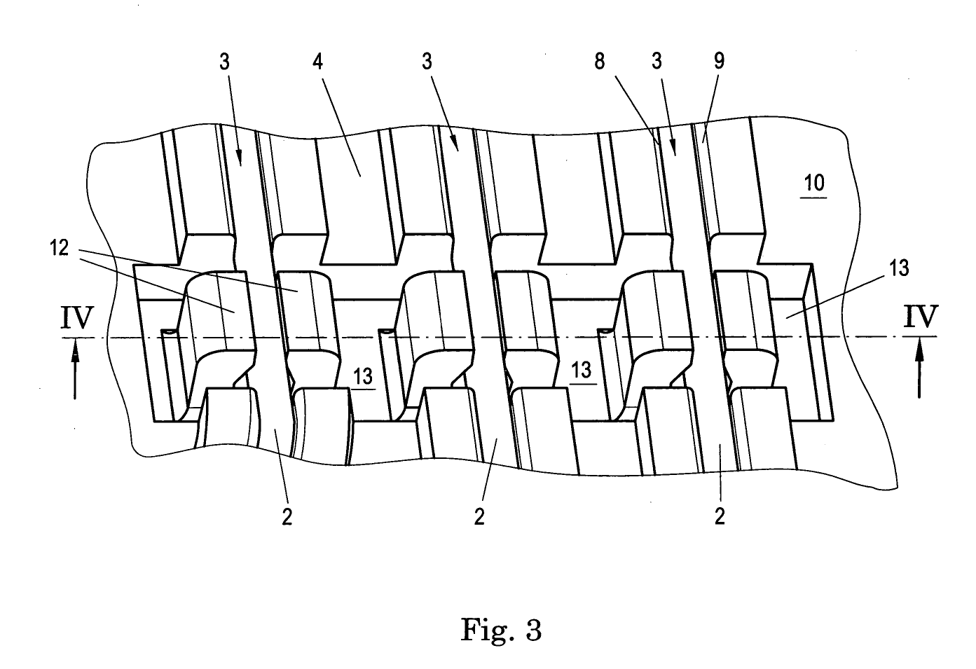

In addition to the channel-shaped receptacles 3, optionally also instead of these channel-shaped receptacles 3, also receptacles having the form of clamping elements or retention clips 12 may be provided for fixing the wires 2. In detail, as is particularly visible in FIGS. 3 and 4, these are pairs of resiliently deflectable claws 12a, 12b which pairwise retain the respective wire in a snap fit, or latching fit, respectively; for technical reasons of injection molding, the carrier plate 4 has openings in the region between two claws 12a, 12b of such a retention clip 12, as illustrated at 12c in FIG. 4. Seen in top view, immediately following the respective retention clips 12, however, the body 10 of the carrier plate 4 is present again, so that there the respective wire 2 rests on the main body 10 of the carrier plate 4, to be more precise on the groove bottom of the receptacle 3, and in this way the wire 2 can be tightly held against the main body 10 of the carrier plate 4 by the obliquely downwardly inclined oblique surfaces of the claws 12a, 12b of the retention clips 12 visible from the illustrations in FIGS. 3 and 4. Externally of the individual retention clips 12, the main body 10 of the carrier plate 4 is sunk in, cf. the depressions 13 in FIGS. 3 and 4, so as to facilitate the elastic resilient movement of the clamping parts, i.e. the claws 12a, 12b of the retention clips 12, necessary when pressing-in the wires 2.

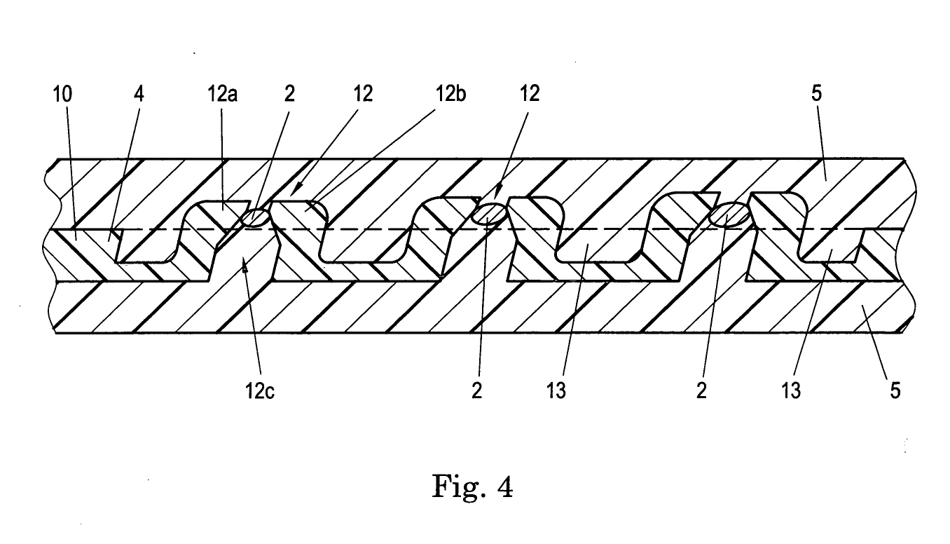

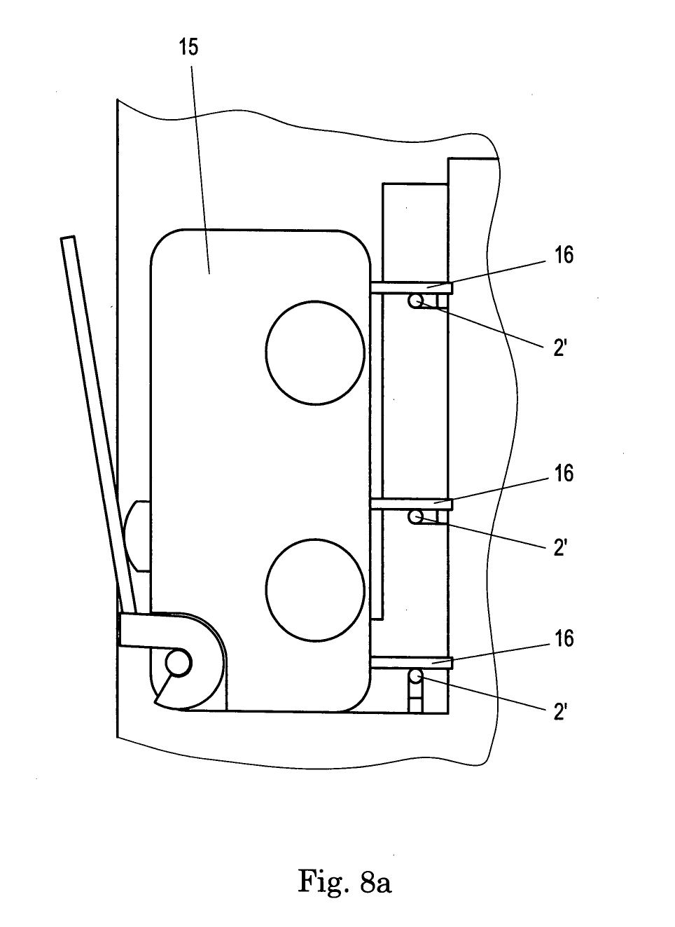

In FIGS. 5 to 7, a comparable conductor structure component 1 having a plate-shaped carrier body, i.e. a carrier plate 4 (cf. FIG. 7) and an injected around plastics material body 5, is shown; moreover, external components, such as, e.g., a small electric motor 14 and a switch 15, are mounted on this component 1, on the plastics material 5 injected therearound. The switch 15 is designed e.g. as a push-button switch, and its terminals 16 are electrically connected to end pieces 2′ of the wires 2, e.g. by soldering or by welding, which end pieces 2′ are bent upwards from the plane of the carrier plate 4. The upwardly projecting end pieces 2′ of the wires 2 are particularly visible in FIG. 9, in which the carrier plate 4 is illustrated without the injected-around plastics material 5, yet with the wires 2 laid into the channel-shaped receptacles 3. Similarly, two end pieces 2′ of the wires 2 in the region illustrated on the top right-hand side in the illustration of FIG. 9, are electrically connected to terminals 17 of the motor 14, e.g. also by soldering or by welding.

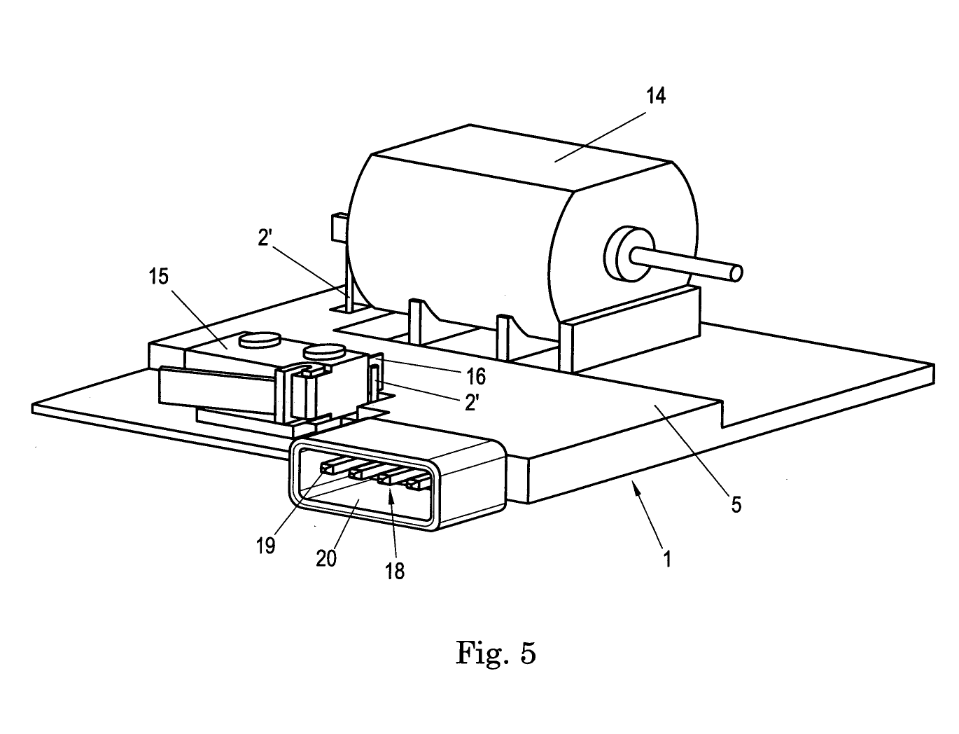

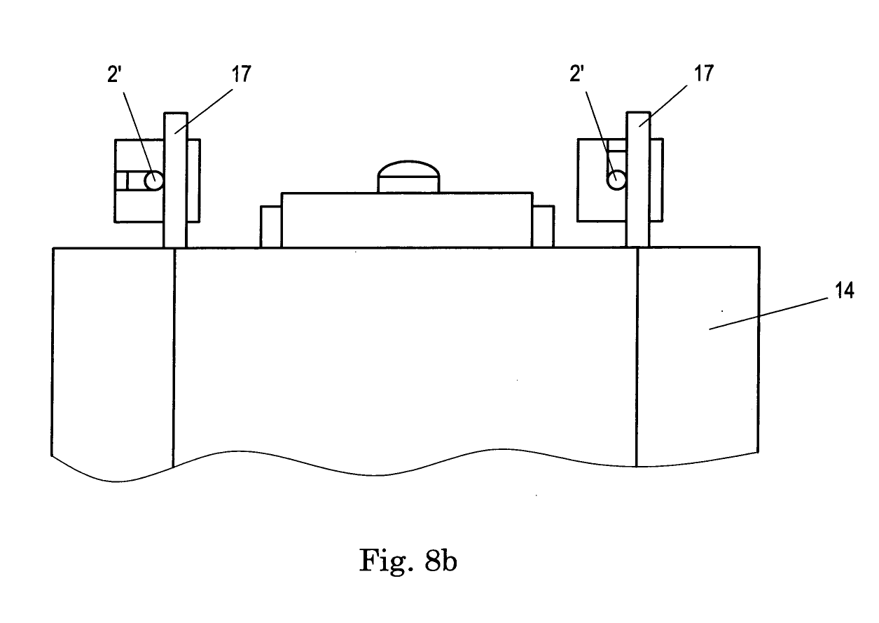

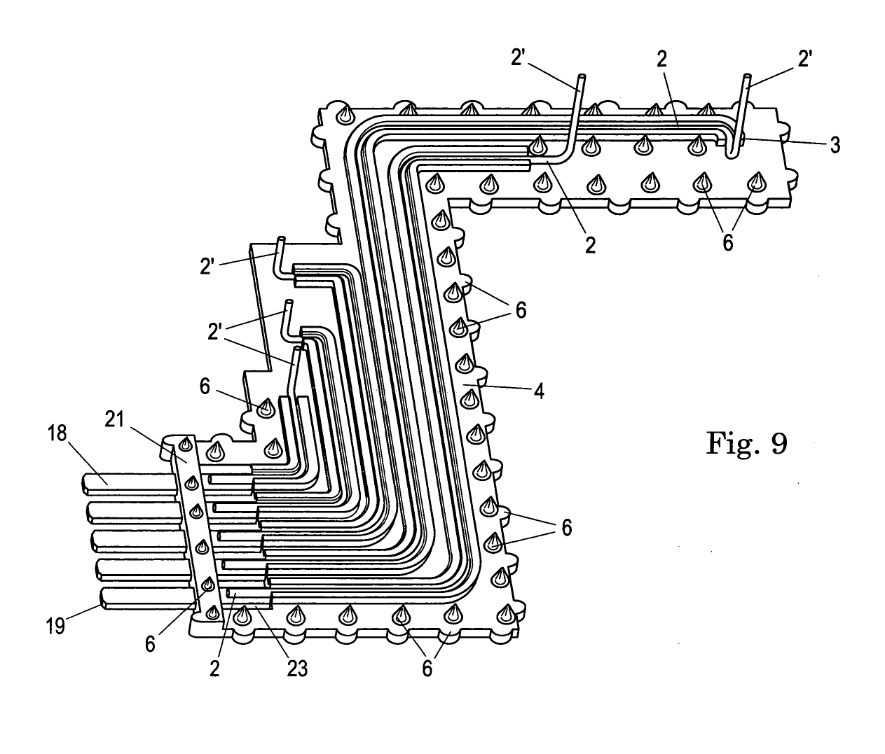

From FIGS. 5 and 6 just as particularly also from FIGS. 9 to 11 it can be seen that for electrically connecting the component 1, plug contacts 18 with individual contact pins 19 are provided which laterally project from component 1 on the rim side thereof and which, in the finished component 1, are surrounded by a housing-shaped encasement 20 which protectingly and sealingly surrounds the plug contacts 18. This encasement 20 is integrally formed with the injected-around plastics material 5, i.e. the plastics body produced when the plastics material is injected around the carrier plate 4 including the wires 2.

As can be seen from FIGS. 9 to 11, the individual contact pins 19 are fixed to the carrier plate 4 on the lower side thereof by tightly clamping them in appropriate latch-in or snap-in seats of the carrier body 4. In doing so, the metal contact pins 19 are pressed into undercut grooves of a bridge portion 21 of the carrier plate 4 on the lower side thereof and latched in or snapped in there, just as in end-side grooves or recesses 22 on the lower side of the carrier plate 4 into which the pins 19 project with their inner ends 23. In the region of these inner ends 23, the pins 19 are electrically connected to the wires 2, e.g. by soldering or welding or by cutting edge contacts, optionally also by mere clamping or the like contacting techniques.

Besides, the nodule-like spacer elements 6 on the carrier plate 4 are also visible in FIGS. 9 to 11, the spacers 6 serving for positioning the carrier plate 4 including the wires 2 in the injection molding tool (not illustrated). The carrier plate 4 as well as the plastics material 5 injected therearound consist of a suitable plastics material chosen according to the purpose, for which the component 1 is used, e.g. of a thermoplast. Preferably, the same plastics material is used both for producing the carrier plate 4 and for the plastics material body 5 injected therearound. As examples of plastics materials to be used, PE (polyethylene), ABS (acrylonitrile-butadiene, styrene), POM (polyoxymethylene), PBT (polybutylene-terephthalate) with/without glass fiber, PP (polypropylene) with/without glass fiber and PA (polyamide) with/without glass fiber shall be mentioned.

Quite generally and as required, the wires 2 may extend in component 1 along a straight line, arcuately, angled by 90° etc. . Depending on the course the wires 2 take, channel-shaped receptacles 3 or retention clips 12 may, e.g. be suitable for fixing the wires 2 to the carrier plate 4. The retention clips 12 are particularly advantageously used where great forces will occur due to a greater change in direction in the course of the wires 2, cf. FIGS. 2 and 3, where the retention clips 12 are mounted in the vicinity of rectangular changes of direction in the course of the wires 2.

When producing a component 1 with electric conductor structure, as described before, at first a carrier body 4 is produced, in particular injection-molded from a plastics material, wherein with the body 10 proper also the parts (walls 8, 9) forming the receptacles 3, or the retention clips 12, respectively, are co-injection-molded in one piece therewith.

By means of a wire insertion robot, the wires 2 are then laid into the receptacles 3 in the carrier body 4, the wires 2, as described, being fixed by a slight press fit and/or by latching and/or by embossing (preferably during the wire insertion) and/or by means of retention clips 12.

The carrier body 4 which in this manner has been equipped with the wires 2 is then provided with the finishing injection-molded plastics body 5 in an injection-molding tool, wherein this injected-around plastics material 5 optionally may also be formed with appropriate mounting regions for external components to be subsequently mounted, such as the motor 14 or the switch 15 of FIG. 5.

If plug contacts 18 are provided, the wires 2 will be connected to these plug contacts 18, e.g. by welding or soldering etc., before injection-molding of plastics material 5 around it takes place.

Besides, it is also possible to mount on said carrier body 4 components to be embedded in the injected-around plastics material, before the former is injected-around, as known per se from EP 1 357 774 A1. In particular, sensors injected around in this manner (e.g. capacitative or inductive sensors, respectively, and/or thermal or pressure sensors, respectively) can be provided.

When producing the injection-molded plastics material 5, the nodule-shaped spacers 6 serve to position the carrier body 4 in the respective injection-molding tool, as mentioned before, i.e. the carrier body 4 abuts with these spacers 6 on the mold walls of the injection-molding tool. In the region of the bent endside wire pieces 2′ of the wires 2, corresponding recesses must be provided in the mold of the injection-molding tool.

By way of FIGS. 12 to 17, a technique will now be described with which the wires 2 are fixed in the receptacles 3 of the carrier body 4 which, again, preferably is plate-shaped (and therefore simply will be termed carrier plate 4 hereinafter) by embossing.

In detail, in FIG. 12 a carrier plate 4 with channel-shaped wire receptacles 3 is shown, this carrier plate 4 with the receptacles 3 in turn constituting a fixing member 4′ for the electric conductors yet to be attached, namely wires 2. According to the illustration in FIG. 12, the carrier plate 4 again is provided with spacers 6, particularly in the form of nodules or knobs, as illustrated, so as to keep the carrier plate 4 at an appropriate distance from the mold walls of the injection-molding tool when being finally injected around so as to produce the injected-around body 5 (cf. eg., FIG. 1 or FIG. 7).

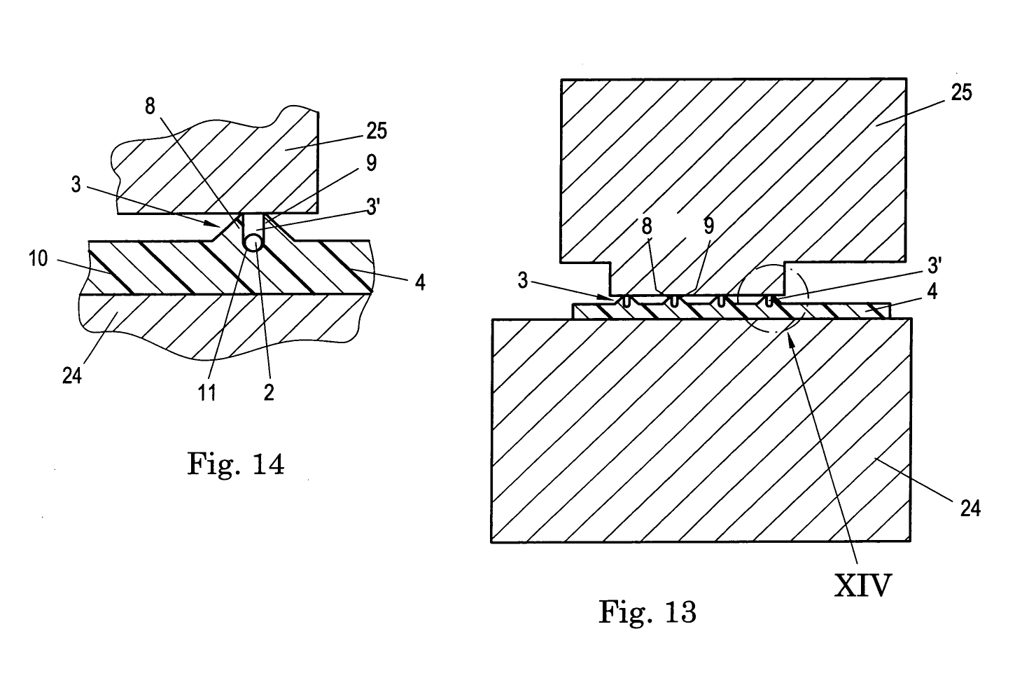

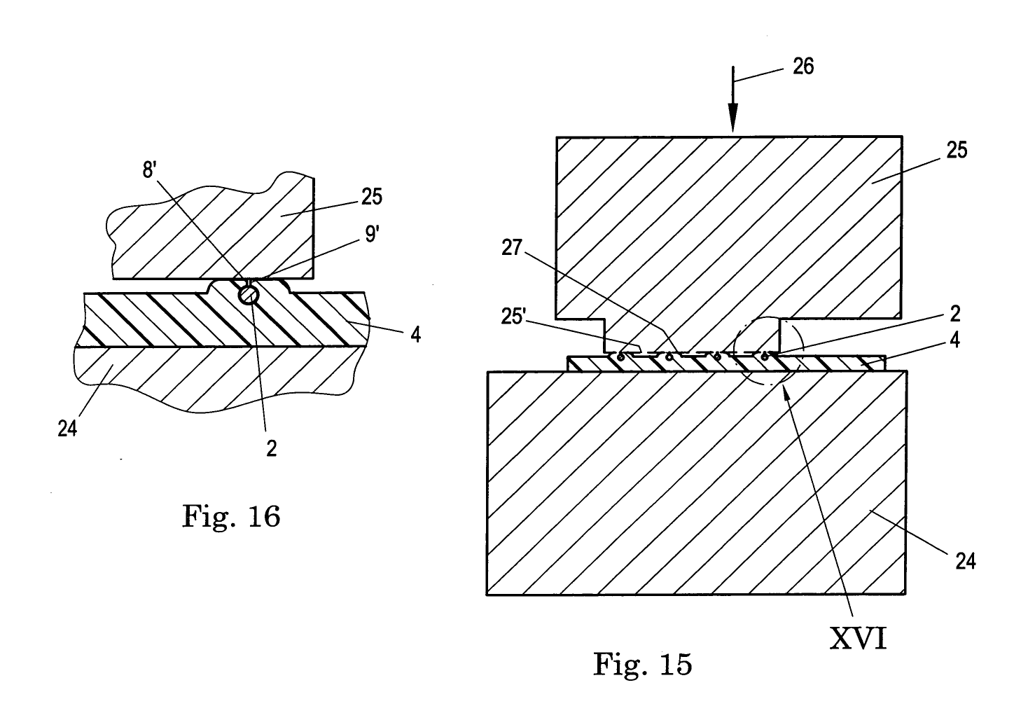

According to FIG. 12, the carrier plate 4 which, again, in particular can be pre-produced from plastics material by injection molding, is mounted on a rigid substructure 24 which (as will be explained by way of FIGS. 15 and 16) in the subsequent embossing step will serve as a counter-tool or counter-die.

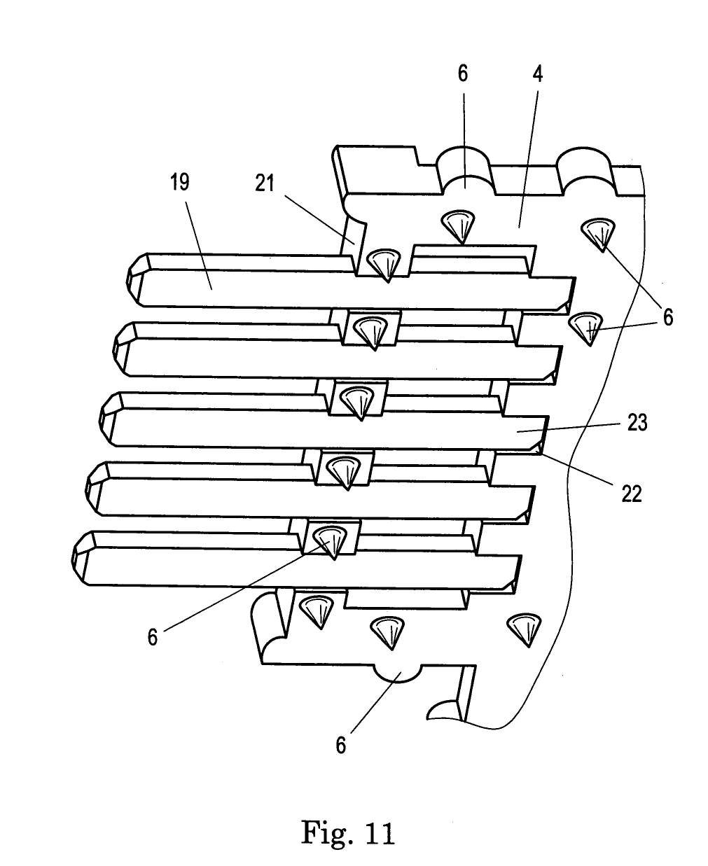

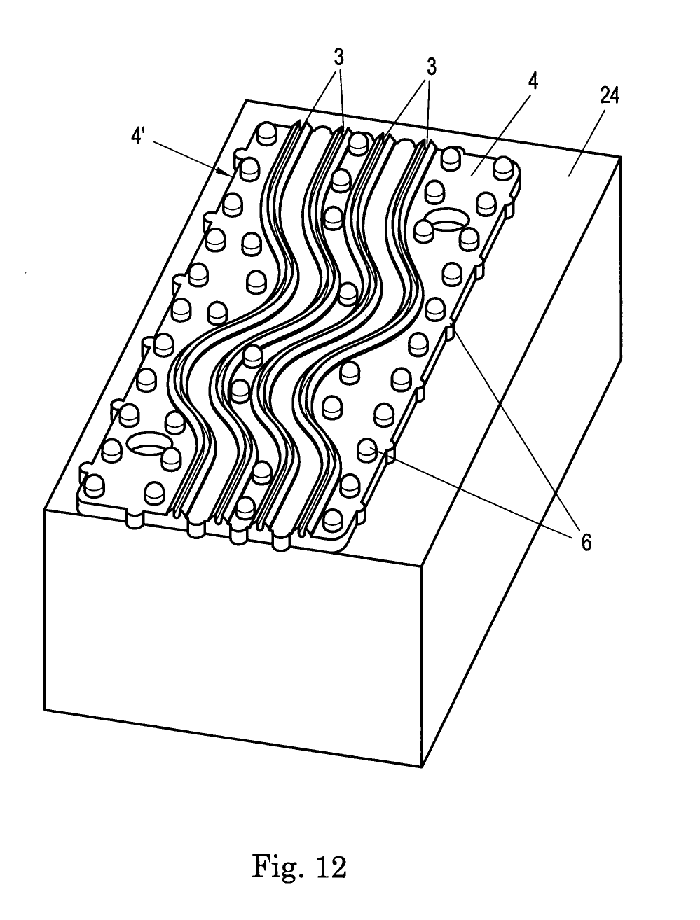

After the carrier plate 4 has thus been fixed to the substructure 24, according to FIG. 12, the carrier plate 4 is clampingly fixed by a tool having the form of an embossing stamp 25, as is visible in FIG. 13. The embossing stamp 25 thereby closes the open upper sides of the receptacles 3 for the wires to be inserted (cf. FIG. 14). The receptacles 3 with the upright walls 8, 9 as well as with the bottom side of the embossing stamp 25 now define tunnel-shaped channels 3′ which, viewed in cross-section, are closed on all sides.

Then the wires 2 are length-wise pushed into these tunnel-shaped channels 3′, e.g. by means of an advancing automat known per se, so that an arrangement as visible in detail in FIG. 14 for one of the receptacles 3 of the carrier plate 4 will result. From FIG. 14 it appears that the channel 3′ is closed on its upper side by the embossing stamp 25; laterally, the walls 8, 9 delimit the channel 3′ whose bottom is formed by a depression or groove 11 in the body 10 of the carrier plate 4 (i.e. the bottom of which is located at a lower level as compared to the upper side of the carrier plate 4, i.e. the upper surface adjoining the walls 8, 9). In this case, the carrier plate 4 continues to rest on the substructure 24, and in the simplest case it may suffice to simply put the carrier plate 4 onto the substructure and, by approaching the embossing stamp 25—cf FIGS. 13 and 14—press it clampingly against the substructure 24. However, also mounting by means of separate clamping holders, stops or suction holes not illustrated is conceivable.

From FIG. 15 and, in detail from FIG. 16 it can be seen that after the previously described pulling in or pushing in of the wires 2 into the channels 3′ of the receptacles, the embossing stamp 25 is moved further downwards for a deforming stroke according to arrow 26 in FIG. 15, whereby the walls 8, 9 will become plastically deformed so that parts covering the inserted wire 2 will be formed in the manner of undercut portions or coverings 8′, 9′, cf. FIG. 16. For this purpose, the embossing stamp 25 may simply have a smooth bottom side, as is apparent from FIGS. 13 and 14, and as illustrated in FIG. 15 by a broken line 25′. It is, however , also conceivable to provide pocket-like mold depressions in the region of the receptacles 3 of the carrier plate 4, aligned with the former, as is apparent from FIG. 15 at 27.

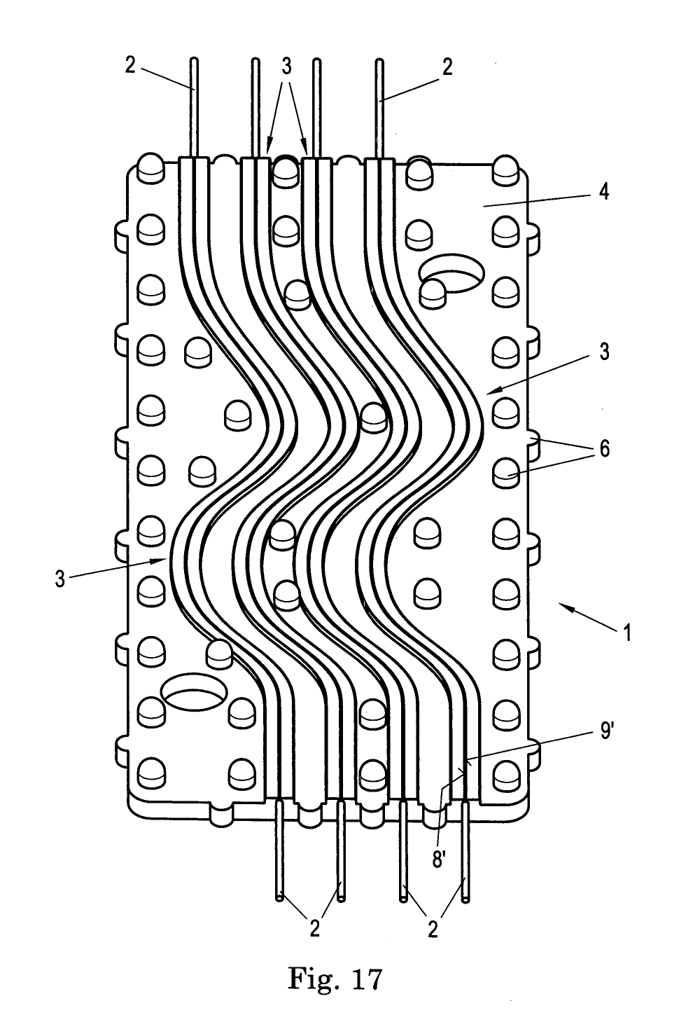

FIG. 17 shows in a perspective view the thus-obtained conductor component 1 with the carrier plate 4 and with the wires 2 positively held by embossing in the receptacles 3 thereof, wherein subsequently the already previously explained injecting around with plastics material is to be effected by using the nodule projections 6 as spacers in the injection-molding tool.

Of course, also in the case of the exemplary embodiment according to FIGS. 12 to 17 it is possible to attach electric components, such as switches, sensors, motors etc. to the carrier plate 4 or, generally, to the carrier body, just as the plug contacts especially described by way of FIGS. 9 to 11 are possible.

1. A fixing member for electric conductors for the production of a conductor structure component by injecting plastics material therearound, said fixing member comprising a prefabricated carrier body with receptacles for the retention of individual wires as electric conductors.

2. The fixing member according to claim 1, wherein the carrier body is injection-molded of a plastics material.

3. The fixing member according to claim 1, wherein the carrier body is plate-shaped.

4. The fixing member according to claim 1, wherein the carrier body comprises spacers.

5. The fixing member according to claim 1, wherein the receptacles of the carrier body at least partially form a press fit for the wires.

6. The fixing member according to claim 1, wherein channel-shaped receptacles for the wires are provided on the carrier body.

7. The fixing member according to claim 6, wherein at least one channel-shaped receptacle at least in regions thereof comprises an undercut portion for retaining the wire received therein.

8. The fixing member according to claim 6, wherein the channel-shaped receptacles at least partially are delimited by upstanding channel walls.

9. The fixing member according to claim 6, wherein the channel-shaped receptacles at least partially are formed by depressions in the carrier body.

10. The fixing member according claim 1, wherein the carrier body comprises at least one elastically deformable retention clip as a snap fit for the respective wire.

11. The fixing member according to claim 10, wherein the retention clip is provided in the region of a curved course of the wire on the carrier body.

12. The fixing member according claim 1, wherein plug contacts are fixed to the carrier body at the rim side thereof.

13. The fixing member according to claim 12, wherein the plug contacts are clamped to the carrier body.

14. The fixing member according claim 1, wherein the wires are retained in the receptacles.

15. The fixing member according to claim 12, wherein the wires are electrically connected to the plug contacts.

16. The fixing member according to claim 15, wherein the wires are connected to the plug contacts by at least one of the means selected from the group comprising soldering, welding, cutting edge contacts and clamping.

17. The fixing member according to claim 14, wherein at least some wires are bent away from the carrier body and project upwards for connection with an electric component.

18. The fixing member according to claim 17, wherein the component is one of a switch or an electric motor.

19. An electric conductor structure component comprising a fixing member according to claim 1 and electric conductors within a plastics material injected therearound, wherein wires are retained in receptacles of the carrier body of the fixing member, and wherein the carrier plate including the wires are embedded by plastics material being injection-molded therearound.

20. The conductor structure component according to claim 19, wherein the wires at least partially are held in the receptacles in a press fit.

21. The conductor structure component according to claim 19, wherein the wires at least partially are held in a snap fit in a channel-shaped receptacle having an undercut portion.

22. The conductor structure component according to claim 19, wherein the wires at least partially are held by positive engagement in a channel-shaped receptacle having an overlapping portion produced by embossing.

23. The conductor structure component according to claim 19, wherein the carrier body comprises at least one retention clip which is elastically deformable be-fore the plastics material is injected therearound, provided as a snap retention means for the accommodated wire.

24. The conductor structure component according to claim 23, wherein the retention clip is provided in the region of a curved course of the wire on the carrier body.

25. The conductor structure component according to claim 19, wherein plug contacts are fixed to the carrier body, the wires being electrically connected to said plug contacts and projecting from the plastics material injected therearound.

26. The conductor structure component according to claim 25, wherein the plastics material injected therearound forms an encasement part surrounding the plug contacts.

27. The conductor structure component according to claim 19, wherein at least some wires are bent away from the carrier body and extend to the outside through the plastics material injected therearound for connection to an outer electric component.

28. The conductor structure component according to claim 19, wherein the carrier body comprises spacers which are located within the injected-around plastics material and at least partially extend as far as to the outer side thereof.

29. A method of producing an electric conductor structure component, said method comprising the steps of producing a carrier body having receptacles for wires, providing and inserting wires as electric conductors in the receptacles of the carrier body and fixing them in their position therein, and injection-molding plastics material around the carrier body including the wires.

30. The method according to claim 29, wherein the carrier body is produced by injection-molding of plastics material.

31. The method according to claim 29, wherein the wires at least partially are fixed in the receptacles by means of a press fit.

32. The method according to claim 29, wherein the wires at least partially are fixed to the carrier body by means of a snap retention.

33. The method according to claim 29, wherein the wires at least partially are fixed to the carrier body by means of embossing.

34. The method according to claim 33, wherein after an embossing stamp has been approached to the upper side of the receptacles formed with upright walls so as to close them, the wires are pushed into the then tunnel-like receptacles produced during said closing action.

35. The method according to claim 34, wherein the up-right walls of the receptacles are deformed by an em-bossing stroke of the embossing stamp under formation of an undercut portion or covering after the wires have been pushed therinto.

36. The method according to claim 29, wherein the carrier body is automatically equipped with said wires.

37. The method according to claim 29, wherein at least in a rim region of the carrier body, plug contacts are fixed before they are injection-molded therearound, the wires being electrically connected to said plug contacts.

38. The method according to claim 37, wherein said plug contacts are tightly clamped before they are injection-molded therearound.

39. The method according to claim 37, wherein the wires are electrically connected to said plug contacts by at least one of the means selected from the group comprising soldering, welding, clamping and cutting edge contacts.

40. The method according to claim 29, wherein at least some wires are bent upwards from the carrier body, wherein the upwardly projecting wire portion is so long that it will project from the injected material for contacting purposes, after it has been injected around with plastics material.

41. The method according to claim 29, wherein the carrier body is produced with spacers which support the carrier body in the tool when injection-molding is effected therearound.
